(19) United States
(12) Patent Application Publication
(10) Pub. No.: US 2008/0080465 A1
(43) Pub. Date: Apr. 3, 2008

(54) Transmission time interval allocation for packet radio service

(75) Inventors: Kari Pajukoski, Oulu (FI); Esa Tiirola, Kempele (FI); Mika Rinne, Espoo (FI); Pasi Kinnunen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/592,260

(22) Filed: Nov. 3, 2006

(30) Foreign Application Priority Data
Sep. 29, 2006 (FI) 20065614

(51) Int. Cl. H04B 7/216

(52) U.S. Cl. 370/342

(57) ABSTRACT

It is provided a solution for selecting the length of a transmission time interval for high-speed packet radio communications between a base station and a mobile station. The length of the transmission time interval used in data transfer is selected on the basis of channel conditions between the mobile station and the base station. An average value for a channel quality metric representing the channel conditions is calculated and the calculated average value of the channel quality metric is associated with a pre-determined length of the transmission time interval. That length of the transmission time interval is then selected for the data transfer between the mobile station and the base station.

### FIELD

The invention relates to data transmission in a mobile telecommunication system supporting a high-speed packet radio service.

### BACKGROUND

In 3GPP (3^{rd} Generation Partnership Project), orthogonal frequency division multiple access (OFDMA) has been selected for a radio access scheme in the long-term evolution of a 3^{rd} generation mobile telecommunication system. In particular, scalable OFDMA (S-OFDMA) will be the radio access scheme for the downlink, and single-carrier FDMA will be the radio access scheme for the uplink. In OFDM, information is transmitted on a plurality of subcarriers on a given frequency band. In an ideal case the subcarriers are mutually orthogonal, i.e. they do not interfere one another.

In a high-speed packet radio service based on OFDM, a number of adjacent subcarriers are included in one resource block, and a number of such resource blocks are allocated to a number of mobile stations for data transmission. Re-allocation of the resource blocks may be performed at sufficient time intervals such that it is possible to adapt to a changing radio environment and allocate the resource blocks accordingly. The allocation of resource blocks is typically carried out by a base station. The base station obtains knowledge of the radio environment experienced by each mobile station directly from the mobile stations or by calculating channel properties from signals received from the mobile station. On the basis of the knowledge on the radio environment, the base station carries out scheduling, i.e. frequent allocation, of the resource blocks to the mobile stations. Thus, communications between the base station and the mobile stations share the radio resources through fast scheduling of packets to a short-term allocation. The allocation of radio resources for both the uplink and the downlink are signaled through downlink.

Scheduling of resource blocks amongst multiple mobile stations for data transmission on both the uplink and downlink requires a significant amount of control signaling. The scheduling may be carried out with a few millisecond intervals, for example, and control information indicating the allocation of resource blocks to corresponding mobile stations may be transmitted to the mobile stations with the same intervals. As a consequence, it is obvious that the amount of control signaling is significant, and that a need exists for rationalizing the signaling overhead.

### BRIEF DESCRIPTION OF THE INVENTION

An object of the invention is to provide an improved data transmission method in a mobile telecommunication system.

According to an aspect of the invention, there is provided a method for selecting the length of a transmission time interval for data transfer between a mobile station and a base station. The method comprises calculating an average value for a channel quality metric representing the quality of a radio channel between the mobile station and the base station communicating according to a frequency division multiplexing based high-speed packet radio service. The method further comprises associating the calculated average value of the channel quality metric to a pre-determined length of a transmission time interval for transfer of data between the mobile station and the base station, and selecting for use in the data transfer between the mobile station and the base station, the length of the transmission time interval associated with the calculated average value of the channel quality metric.

According to another aspect of the invention, there is provided an apparatus, comprising a processing unit configured to obtain an average value for a channel quality metric representing the quality of a radio channel between a mobile station and a base station communicating according to a frequency division multiplexing based high-speed packet radio service, associate the calculated average value of the channel quality metric to a pre-determined length of a transmission time interval for transfer of data between the mobile station and the base station, and select for use in the data transfer between the mobile station and the base station, the length of the transmission time interval associated with the calculated average value of the channel quality metric.

According to another aspect of the invention, there is provided an apparatus comprising an interface and a processing unit. The interface is configured to transmit and receive signals transferred between a mobile station comprising the apparatus and a base station, the mobile station and the base station communicating according to a frequency division multiplexing based high-speed packet radio service. The processing unit is configured to calculate an average value for a channel quality metric representing the quality of a radio channel between the mobile station and the base station, transmit, through the interface, the average value of the channel quality metric to the base station for allocation of the length of a transmission time interval for data transfer between the mobile station and the base station, and receive, through the interface, a control signal comprising information on the length of the transmission time interval allocated to the mobile station for data transfer.

According to another aspect of the invention, there is provided a mobile telecommunication system comprising a base station and at least one mobile station. The base station comprises a communication interface to provide radio communications with the mobile station and a processing unit configured to obtain an average value for a channel quality metric representing the quality of a radio channel between a mobile station and a base station communicating according to a frequency division multiplexing based high-speed packet radio service, associate the calculated average value of the channel quality metric to a pre-determined length of a transmission time interval for transfer of data between the mobile station and the base station, and select for use in the data transfer between the mobile station and the base station, the length of the transmission time interval associated with the calculated average value of the channel quality metric. The mobile station comprises a communication interface to provide radio communications with the base station and a processing unit configured to receive, through the communication interface, a control signal comprising information on the length of the transmission time interval allocated to the mobile station for data transfer and transfer data with the base station in transmission time intervals of the allocated length.

According to another aspect of the invention, there is provided a mobile telecommunication system comprising a base station and at least one mobile station. The base station comprises a communication interface to provide radio communications with the mobile station and a processing unit configured to receive an average value for a channel quality metric representing the quality of a radio channel between the mobile station and the base station communicating according to a frequency division multiplexing based high-speed packet radio service, associate the calculated average value of the channel quality metric to a pre-determined length of a transmission time interval for transfer of data between the mobile station and the base station, select for use in the data transfer between the mobile station and the base station, the length of the transmission time interval associated with the calculated average value of the channel quality metric, and transmit to the mobile station a control signal comprising information on the length of the transmission time interval selected for the mobile station for data transfer. The mobile station comprises a communication interface to provide radio communications with the base station and a processing unit configured to calculate an average value for a channel quality metric representing the quality of a radio channel between the mobile station and the base station, transmit, through the communication interface, the average value of the channel quality metric to the base station, and receive, through the interface, a control signal comprising information on the length of the transmission time interval selected for the mobile station for data transfer.

According to another aspect of the invention, there is provided a computer program distribution medium readable by a computer and encoding a computer program of instructions for executing a computer process for selecting a length of a transmission time interval for data transfer between a mobile station and a base station. The process comprises obtaining an average value for a channel quality metric representing the quality of a radio channel between the mobile station and the base station communicating according to a frequency division multiplexing based high-speed packet radio service, associating the calculated average value of the channel quality metric with a pre-determined length of a transmission time interval for transfer of data between the mobile station and the base station, and selecting for use in the data transfer between the mobile station and the base station, the length of the transmission time interval associated with the calculated average value of the channel quality metric.

According to another aspect of the invention, there is provided a computer program distribution medium readable by a computer and encoding a computer program of instructions for executing a computer process. The process comprises calculating an average value for a channel quality metric representing the quality of a radio channel between a mobile station and a base station communicating according to a frequency division multiplexing based high-speed packet radio service, transmitting the calculated average value of the channel quality metric to the base station for selection of the length of a transmission time interval for the mobile station, and receiving a control signal comprising information on the length of the transmission time interval allocated to the mobile station for data transfer.

### LIST OF DRAWINGS

In the following, the invention will be described in greater detail with reference to embodiments and the accompanying drawings, in which

FIG. 1 illustrates an example of a structure of a mobile telecommunication system to which embodiments of the invention may be applied;

FIG. 2 illustrates an example of a frame structure used in a high-speed packet radio service;

FIG. 3 illustrates communication between a base station and a mobile station according to an embodiment of the invention;

FIG. 4A illustrates an example of data transfer according to an embodiment of the invention;

FIG. 4B illustrates an example of data transfer according to another embodiment of the invention;

FIG. 5A illustrates transmissions and retransmissions of data packets belonging to different hybrid automatic repeat request (HARQ) processes of a mobile station when the length of a transmission time interval is one sub-frame;

FIG. 5B illustrates adaptation of transmissions and retransmissions of data packets belonging to different HARQ processes of the mobile station when the length of a transmission time interval is two sub-frames, and

FIG. 6 is a flow diagram illustrating a process for selecting a length of a transmission time interval of a high-speed packet radio service according to an embodiment of the invention.

### DESCRIPTION OF EMBODIMENTS

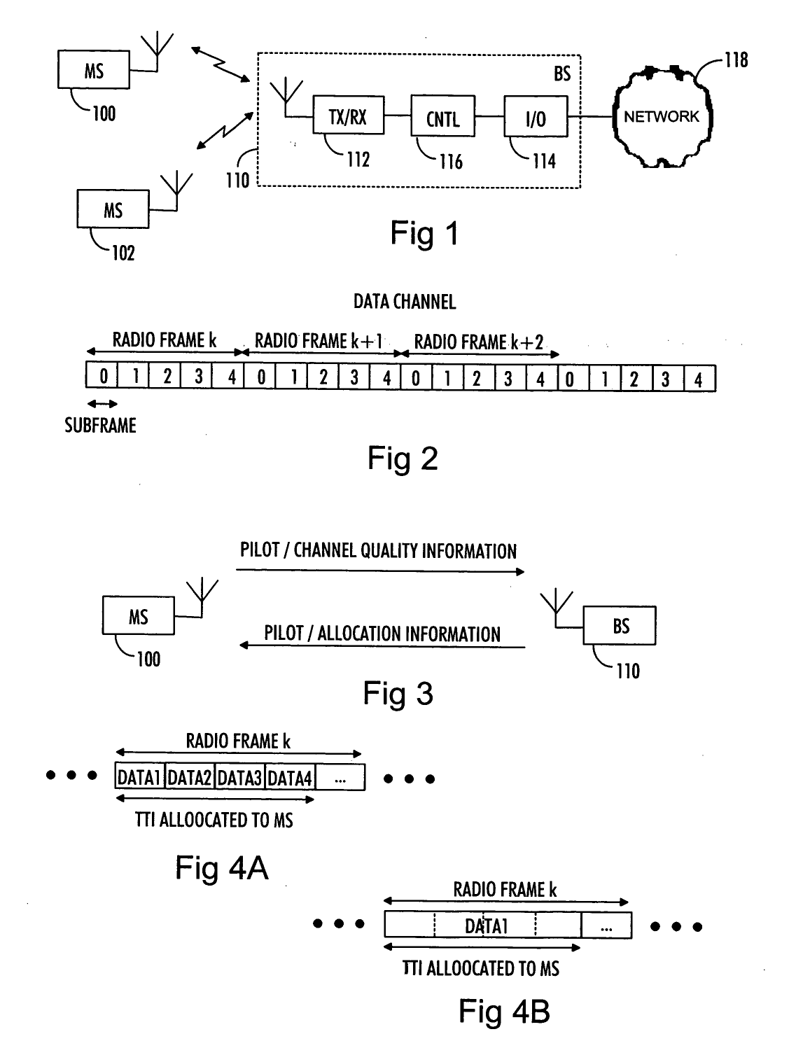

With reference to FIG. 1, let us examine an example of a mobile telecommunication system to which embodiments of the invention can be applied. The mobile telecommunication system may be, for example, a 3^{rd} generation mobile telecommunication system capable of providing a high-speed packet radio service. The mobile telecommunication system may be what is called today a long-term evolution (LTE) of the 3^{rd} generation mobile telecommunication system. Mobile stations 100 and 102 communicate wirelessly with a base station 110 over a wireless communication link. The base station 110 may provide the mobile stations 100 and 102 with a high-speed packet radio service based on Orthogonal Frequency Division Multiplexing (OFDM) technology. As a data transmission scheme, OFDM is obvious to one skilled in the art and, therefore, description of the details of OFDM is omitted. Instead of an OFDM symbol structure, the radio service may be based on any other means for transforming transmission signals to a frequency domain presentation having a multi-carrier or a single-carrier signal structure. Accordingly, the embodiments of the invention may be applied to any frequency division multiplexing based radio service.

The base station 110 may comprise a first communication interface 112 to provide an air interface connection to one or several mobile subscriber units 100, 102. The first communication interface 112 may perform analog operations necessary for transmitting and receiving radio signals. Such operations may comprise analog filtering, amplification, up/down conversions, and A/D (analog-to-digital) or D/A (digital-to-analog) conversion.

The base station 110 may further comprise a second communication interface 114 to provide a wired connection to a network 118 of the telecommunication system. The network 118 of the telecommunication system may provide connections to other networks, such as other mobile telecommunication systems, the Internet, and Public Switched Telephone Network (PSTN).

The base station 110 may further comprise a processing unit 116 to control functions of the base station 110. The processing unit 116 handles establishment, operation and termination of radio connections with the mobile subscriber units 100, 102 the base station 110 is serving. The processing unit 116 may also control allocation of radio resources to the mobile stations 100, 102. The allocation of radio resources may comprise allocating available resource blocks, each comprising a plurality of OFDM subcarriers, to the mobile stations at determined time intervals. The processing unit 116 may be implemented by a digital signal processor with suitable software embedded in a computer readable medium, or by separate logic circuits, for example with ASIC (Application Specific Integrated Circuit).

The mobile station 100 or 102 may comprise a communication interface to provide a radio connection with the base station. The communication interface may perform analog operations necessary for transmitting and receiving radio signals.

The mobile station 100 or 102 may further comprise a processing unit to control functions of the mobile station 100 or 102. The processing unit may handle establishment, operation and termination of radio connections with the base station. The processing unit may be implemented by a digital signal processor with suitable software embedded in a computer readable medium, or by separate logic circuits, for example with ASIC (Application Specific Integrated Circuit).

The mobile station 100 or 102 may additionally comprise a user interface for interaction with a user of the mobile station 100 or 102. The user interface may comprise a display, a keypad or a keyboard, a loudspeaker, a microphone, etc.

FIG. 2 illustrates an example of a structure of a radio frame used in high-speed data packet communication between the base station 100 and the mobile stations 100, 102. The radio frame (k, k+1, k+2, etc.) may be divided into a number of sub-frames which are allocated to the mobile station for data packet transmission. Within sub-frames, the physical resources are allocated to the mobile stations as physical resource blocks, where the physical resource blocks consist of modulated symbols on determined sub-carriers in frequency and on determined OFDM-symbols in time. The sub-frames allocated to a given mobile station are called transmission time intervals of that mobile station. A minimum transmission time interval of the mobile station may be one sub-frame. The base station 100 may schedule the utilization of sub-frame among the mobile stations 100, 102 and provide the mobile stations 100, 102 with control information indicating the resource block and transmission time interval allocated to the corresponding mobile station 100, 102.

According to an embodiment of the invention, the base station 110 may determine the length of the transmission time interval for the mobile station 100 on the basis of at least properties of the radio channel between the base station 110 and the mobile station 100. The embodiments of the invention may be implemented on the uplink and/or downlink.

FIG. 3 illustrates information exchanged between the mobile station 100 and the base station 110. The mobile station 100 may transmit a pilot sequence to the base station 110 periodically on given one or more subcarriers. The pilot sequence may be distributed between the subcarriers with given frequency intervals so that the base station 110 may obtain knowledge on the channel properties related to each resource block available for allocation to the mobile station 100.

The base station 110 may process the received pilot sequence in order to determine the properties of the radio environment between the mobile station 100 and the base station 110 at frequencies (subcarriers) containing the pilot sequence. Accordingly, the base station 110 may calculate a channel quality metric representing the quality of a radio channel between the mobile station and the base station. The channel quality metric may be calculated for each resource block. The channel quality metric may be a signal-to-interference-plus-noise power ratio (SINR) calculated from the received pilot sequence according to a method known in the art. The base station 110 may average the calculated channel quality metric values over time. The averaging period may be sufficiently long so that short-term variations in the calculated SINR values will be averaged out. The averaging period may be, for example, 200 ms.

Alternatively, the channel quality metric may be calculated by the mobile station 100 from a pilot sequence transmitted from the base station 110 to the mobile station 100. The mobile station 100 may calculate, for example, the SINR or a path loss value from the received pilot sequence. The mobile station 100 may have knowledge on the transmit power of the pilot sequence and, therefore, it may calculate the path-loss value. The path-loss value is typically associated with distance and, therefore, the calculated channel quality metric may represent the distance between the mobile station 100 and the base station 110. The mobile station may average the calculated channel quality metrics over time and transmit the averaged channel quality metric values to the base station 110. A channel quality metric value may be calculated for each resource block.

The calculated average channel quality metric values may be used in determining the length of a transmission time interval for the mobile station. It has been discovered that a short transmission time interval (one sub-frame) provides the best overall system capacity in most situations due to fast scheduling and the fact that the channel quality is unlikely to change dramatically within one sub-frame. Thus, the best possible frequency resources can be allocated to each mobile based on the observations of the frequency selective channel, which allows maximizing cell throughput of all mobiles served by the base station 110. As mentioned in the background section, utilization of such a short transmission time interval requires, however, a significant amount of control signaling. In order to reduce the signaling overhead, a longer transmission time interval may be allocated to the mobile station 100 in some situations in order to reduce the signaling overhead. The longer transmission time interval, for example 2 or 4 consecutive sub-frames, may in some cases result in somewhat poorer performance in terms of system capacity, but gains obtained in reduced signaling overhead may result in better system performance. In some situations, for example under poor quality channel environments, the longer transmission time interval may even provide a higher system capacity and improved coverage.

Actually, depending on the transmit power available, a transmission bandwidth of the resource blocks may be determined such that for high distances between the mobile station 100 and the base station 110 the transmit power is concentrated on a relatively narrow frequency band. On the other hand, for short distances the transmit power may be concentrated on a relatively wider frequency band. Thus, depending on the selected transmit power and the size of a Transport Block (of a data packet), it may be a advantageous either to apply a wider transmission band over a shorter transmission time interval or to apply a narrower transmission band over a longer transmission time interval.

The reduction in signaling overhead when allocating a longer transmission time interval is evident. First, let us consider that data is transmitted in four sub-frames such that the allocated length of the transmission time interval is one sub-frame. Accordingly, the base station schedules four transmission time intervals (each having the length of one sub-frame) of a given resource block to the mobile station and has to transmit control signals indicating the scheduling for each allocated transmission time interval. Then, let us consider that the same data is transmitted in four sub-frames such that the allocated length of the transmission time interval is two. Now, the base station schedules two transmission time intervals (each having the length of two consecutive sub-frames) of a given resource block to the mobile station and transmits control signals indicating the scheduling for the two allocated transmission time intervals. Clearly, the amount of control signaling is roughly halved. Finally, let us consider that the same data is transmitted in four sub-frames such that the allocated length of the transmission time interval is four. Now, the base station schedules one transmission time interval (having the length of four consecutive sub-frames) of a given resource block to the mobile station and transmits a control signal indicating the scheduling for the allocated transmission time interval. The amount of control signaling is reduced even more.

In addition to the calculated channel quality metrics, the base station 110 may determine the length of the transmission time interval for the mobile station 100 on the basis of traffic volume associated with the mobile station 100, i.e. the amount of data traffic buffered for transmission to/from the mobile station 100. The base station 110 may obtain knowledge of the amount of data traffic buffered for transmission to the mobile station 100 simply by checking the buffers of the base station 110. On the contrary, the base station 110 may obtain the amount of data traffic buffered into the buffer of the mobile station 100 for transmission from the mobile station 100 to the base station 100 by estimating the amount of data traffic from the previous data transmission properties of the mobile station 100. The base station 110 may estimate the amount of data traffic transmitted recently within a determined time period from the mobile station 100 or determine the amount of data traffic from data transmission parameters used by the mobile station. Alternatively, the mobile station 100 may transmit an indicator describing the amount of data traffic to be transmitted from the mobile station 100. If the determined traffic volume is low, it may be advantageous to use a short transmission time interval, since the short transmission time interval typically provides the highest system capacity. Additionally, there may not be enough data to fill the increased number of sub-frames (four sub-frames, for example). In such cases, the allocation of four transmission time intervals would result in waste of system capacity. On the other hand, if the determined traffic volume is high, it may be advantageous to use a long transmission time interval, since there is enough data to fill the increased number of sub-frames, i.e. the system capacity will not be wasted, and a reduction in signaling overhead is achieved.

The base station 110 may select the length of the transmission time interval that provides the best compromise between the contribution of a given length of the transmission time interval to the overall system capacity and the reduction achieved in the amount of control signaling. In other words, the base station 110 may select the length of the transmission time interval that provides the desired weighting for the amount of required control signaling and achievable system capacity for that range of the channel quality metric value. The knowledge of the effect of different lengths of the transmission time interval in different channel conditions and with different traffic volumes may be obtained from system parameters and through system simulations and/or measurements.

According to an embodiment of the invention, the base station 110 may associate the calculated average value of the channel quality metric with a pre-determined length of a transmission time interval and select the length of the transmission time interval which is associated with the calculated channel quality metric. The base station 110 may comprise a memory unit which stores a table in which a given range of the channel quality metric is associated with a given length of transmission time interval that is known to provide the best compromise between the amount of required control signaling and achievable capacity for that range of the channel quality metric value. The table stored into the memory unit may have, for example, the format illustrated in Table 1 in which S denotes the calculated channel quality metric (average SINR value), allocated TTI length is the length of the transmission time interval, and TH₁ and TH₂ a first and a second threshold value, respectively. The value of TH₂ is higher than the value of TH₁.

TABLE 1

| SINR | Allocated TTI length |
|---|---|
| S < TH₁ | 4 |
| TH₁ ≦ S < TH₂ | 2 |
| S ≧ TH₂ | 1 |

Accordingly, it the calculated average SINR value is lower than the first threshold value TH₁, the length of the transmission time interval may be selected as four. If the calculated average SINR value is equal to or higher than the first threshold TH₁ but lower than the second threshold, the length of the transmission time interval may be selected as two. Otherwise, the length of the transmission time interval may be selected as one.

According to another embodiment of the invention, the base station 110 may associate the estimated data traffic volume together with the calculated average value of the channel quality metric with a pre-determined length of a transmission time interval, and select the length of the transmission time interval which is associated with the estimated data traffic volume and the calculated average value of the channel quality metric. When selecting the length of the transmission time interval on the basis of both traffic volume and channel quality metric, the memory unit of the base station 110 may store a table in which given ranges of traffic volume and channel quality metric are associated with a given length of transmission time interval that is known to provide the best compromise between the amount of required control signaling and achievable system capacity. The table stored into the memory unit may have, for example, the format illustrated in Table 2 in which the determined amount of traffic volume D defines the maximum length of the transmission time interval and the calculated average channel quality metric is used for selecting the appropriate length amongst the possible lengths defined by the traffic volume. In Table 2, D₁ and D₂ denote thresholds for the traffic volume (D₂ is higher than D₁), and TH₃, TH₄, and TH₅ denote thresholds for the channel quality metric (TH₅ is higher than TH₄).

TABLE 2

| | Maximum | | Selected |
|---|---|---|---|
| Traffic volume | TTI length | SINR | TTI length |
| D < D₁ | 1 | — | 1 |
| D₁ ≦ D < D₂ | 2 | S < TH₃ | 2 |
| | | S ≧ TH₃ | 1 |
| D ≧ D₂ | 4 | S < TH₄ | 4 |
| | | TH₄ ≦ S < TH₅ | 2 |
| | | S ≧ TH₅ | 1 |

Accordingly, it the determined traffic volume is lower than threshold D₁, the maximum length of the transmission time interval is one and the selected length of the transmission time interval is one, since that is the only possible choice. If the determined traffic volume is equal to or higher than threshold D₁ but lower than threshold D₂, the maximum length of the transmission time interval is two. Now, if the calculated channel quality metric (SINR) has a value lower than threshold TH₃, the length of the transmission time interval is selected as two. Otherwise, the length of the transmission time interval is selected as one. If the determined traffic volume is higher than threshold D₂, the maximum length of the transmission time interval is four. Now, if the calculated channel quality metric (SINR) has a value lower than threshold TH₄, the length of the transmission time interval is selected as four. If the calculated SINR is equal to or higher than threshold TH₄ but lower than threshold TH₅, the length of the transmission time interval is selected as two. Otherwise, the length of the transmission time interval is selected as one.

When the base station 110 has selected the length of the transmission time interval for the mobile station 100, it may transmit a control signal comprising allocation information to the mobile station 100. The allocation information may comprise the length of the transmission time interval allocated to the mobile station. The base station 110 may transmit the length of the transmission time interval among other transport format information transmitted from the base station 110 to the mobile station 100. The length of the transmission time interval may be signaled to the mobile station as radio resource control signaling, which means that the length of the transmission time interval is a semi-static parameter. Accordingly, no need exists to signal the length of the transmission time interval every time a transmission time interval is scheduled to the mobile station 100 for data transmission/reception. The mobile station 100 may use the allocated length of the transmission time interval in the data transfer until a new length of the transmission time interval is allocated to it. The base station 110 may allocate the same length of transmission time interval to the mobile station for both uplink and downlink communications, or allocate the length of the transmission time interval separately for the uplink and downlink. Obviously, either downlink or uplink communications may be adapted to use a fixed length of the transmission time interval. In such cases, the base station 110 may determine and allocate the length of the transmission time interval only for the link direction for which the length of the transmission time interval is variable.

The base station 110 may allocate the length of the transmission time interval individually for each mobile station the base station 110 is serving. Alternatively, the base station 110 may group the mobile station into groups on the basis of the channel quality metrics and/or the determined traffic volumes associated with the mobile stations. Then, the base station 110 may allocate a determined length of the transmission time interval for each group of mobile stations. As indicated above, the base station 110 may allocate the length of the transmission time interval to mobile stations as an integer number of consecutive sub-frames.

FIGS. 4A and 4B illustrate two examples of how to transmit data within a transmission time interval longer than one sub-frame. In the example illustrated in FIG. 4A, the longer transmission time interval (four consecutive sub-frames of radio frame k) is used for transmitting different payload data in every sub-frame.

In the example illustrated in FIG. 4B, the same data as normally transmitted in a transmission time interval of one sub-frame is transmitted with increased redundancy in the transmission time interval of four sub-frames. This is carried out in order to facilitate detection of the data in a receiver. It is also possible to transmit exactly the same data in every sub-frame (automatic retransmissions of the original sub-frame) in order to improve the coverage area. In such a case, the coding scheme may not change during the repeated blocks (chase combining). An alternative scheme with automatic retransmission is to perform automatic retransmissions based on incremental redundancy. In this scheme, the payload data may be transmitted with a conventional modulation and coding scheme (the same one as would be used in transmission when only one sub-frame is allocated) in one sub-frame and the extra sub-frames of the transmission time interval may be used for transmitting parity bits for the payload data. Alternatively, the payload data may be protected by a stronger channel coding such that the length of the channel-coded symbol sequence corresponds to the length of the transmission time interval, i.e. four sub-frames in this example. The payload data transmitted with extra protection by extra parity bits or stronger channel coding may be priority data for which the correct detection in the receiver is essential. Such data may be, for example, important control information transmitted between the mobile station 100 and the base station 110.

The base station 110 may allocate a variable-length transmission time interval for all channels used in communication with the mobile station 100, or only for a specific channel or channels. The base station 110 may allocate a variable-length transmission time interval for specific control channels containing data for which reliable data transmission is important. For other channels, e.g. data channels, the base station 110 may allocate a fixed-length transmission time interval. For example, the base station 110 may allocate a variable-length transmission time interval for a control channel (or control channels) used for transmitting acknowledgments (ACK/NACK) of data packets and/or channel quality information, and allocate a fixed-length transmission time interval for other channels.

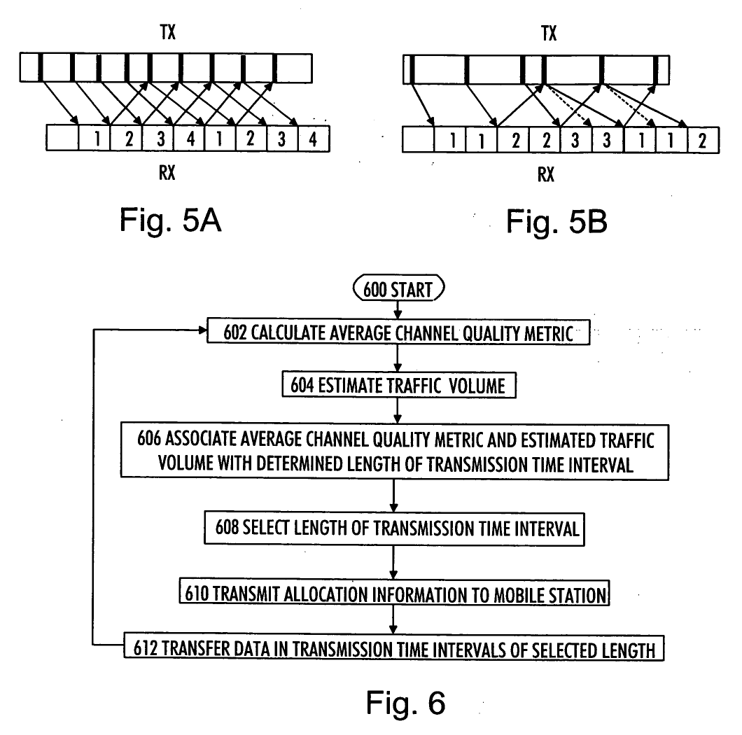

Preferably, when selecting the length of the transmission time interval for the mobile station, Hybrid Automatic Repeat Request (HARQ) retransmission processes may be adapted to the selected length of the transmission time interval. In conventional transmission, where a single length of the transmission time interval is utilized, the HARQ processing cycles are conventionally determined by the processing time requirements set for the base station and for the mobile stations such that data packet delivery times are kept at practical minimum. FIG. 5A illustrates such a process in which the transmission time interval is the minimum of one sub-frame. The boxes with numbers represent transmission time intervals of data packets belonging to different HARQ processes, and the number defines the corresponding HARQ process. As soon as a transmitter receives a negative acknowledgment (NACK) signal and has processed the NACK-signal, the transmitter may transmit a retransmission data packet.

In a presence of variable lengths of the transmission time intervals according to embodiments of the invention, the HARQ process cycles may be adapted to ensure that both data packet transmission resources and the acknowledgement resources are in efficient use. For example, if a transmission time interval longer than the minimum of one sub-frame is selected, it may be necessary to reserve more time for the decoding process of the transport block, which is now larger due to the longer transmission time interval. This may require time matching of the respective HARQ processes. In a situation where the transport block is not larger as a code (or symbol) block, e.g. a selection was made to transmit a transport block on a narrower band over a longer transmission time interval, the HARQ process time matching would be advantageous, too. If minimum HARQ process cycles were applied, the radio resource sharing of different HARQ processes of a mobile station would not align in time and would create overlapping of the HARQ processes. This can be avoided by adapting the HARQ process cycles according to the selected length of the transmission time interval such that the resources allocated by different HARQ processes align efficiently and, as a consequence, will not overlap. FIG. 5B illustrates such an example. Now, the length of the transmission time interval allocated to a mobile station is two sub-frames. If the transmitter transmitted the retransmissions according to the minimum processing time criterion, a retransmission of HARQ process 1 would overlap with a retransmission of HARQ process 3, as indicated by a dashed arrow. Instead of a minimum processing time criterion, the transmission timing of the HARQ processes may be adjusted accordingly to prevent overlapping of (re)transmissions of different HARQ processes. In the example of FIG. 5B, the retransmission of HARQ process 1 is delayed by one sub-frame in order to prevent the overlapping with HARQ process 3 but to enable efficient utilization of the radio resources.

Next, a process for selecting the length of the transmission time interval for data transmission between a base station and a mobile station will be described with reference to a flow diagram illustrated in FIG. 6. The base station may provide the mobile station with a high-speed packet radio service based on OFDM radio communications. The process starts in block 600.

In block 602, an average value for a channel quality metric representing the quality of a radio channel between the mobile station and the base station is calculated. The average value of the channel quality metric may be calculated either in the base station or in the mobile station. If the average value of the channel quality metric is calculated in the mobile station, the mobile station may transmit the average value of the channel quality metric to the base station.

In block 604, the base station estimates the traffic volume between the base station and the mobile station. The traffic volume may be estimated, or traffic volume information may be obtained, as described above.

In block 606, the base station associates the calculated average value of the channel quality metric and the estimated traffic volume with a determined length of a transmission time interval to be used in data transfer between the base station and the mobile station. The base station may perform the association by checking a table stored into a memory unit of the base station in order to find out which length of the transmission time interval is to be selected for the particular values of the calculated channel quality metric and the estimated traffic volume. As a result, in block 608 the base station selects the length of the transmission time interval associated with the calculated average value of the channel quality metric and the estimated traffic volume.

When the base station has selected the length of the transmission time interval, in block 610 the base station transmits the selected length of the transmission time interval to the mobile station in the form of a control signal. In block 612, data is transferred between the base station and the mobile station in transmission time intervals scheduled by the base station. The transmission time intervals have the selected length. From block 612, the process returns to block 602 for calculation of the next average value of the channel quality metric.

The embodiments of the invention may be realized in an apparatus comprising a processing unit. The apparatus according to an embodiment of the invention may be a base station providing a high-speed packet radio service to mobile stations. The apparatus may also comprise a communication interface configured to transmit and receive signals related to communication between the base station and the mobile stations. The processing unit may be configured to perform at least some of the steps described in connection with the flowchart of FIG. 6 and in connection with FIGS. 3, 4A and 4B, and 5A and 5B. The apparatus according to another embodiment of the invention may be a mobile station communicating with a base station providing a high-speed packet radio service. A processing unit of the mobile station may be configured to perform at least some of the steps described in connection with the flowchart of FIG. 6 and in connection with FIGS. 3, 4A and 4B, and 5A and 5B. The embodiments of the invention may be implemented as computer programs comprising instructions for executing computer processes in both the mobile station and the base station for selecting the length of the transmission time interval for data transmission between the base station and the mobile station of a wireless telecommunication system.

The computer programs may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method, comprising:
calculating an average value for a channel quality metric representing the quality of a radio channel between a mobile station and a base station communicating according to a frequency division multiplexing based high-speed packet radio service;
associating the calculated average value of the channel quality metric to a predetermined length of a transmission time interval for transfer of data between the mobile station and the base station; and
selecting for use in the data transfer between the mobile station and the base station, the length of the transmission time interval associated with the calculated average value of the channel quality metric.

2. The method of claim 1, further comprising:
associating a given range of the average value of the channel quality metric with a given length of transmission time interval that provides the desired weighting for the amount of required control signaling and achievable system capacity for that range of the channel quality metric value.

3. The method of claim 1, further comprising:
determining a data traffic volume between the mobile station and the base station;
associating the determined data traffic volume together with the calculated average value of the channel quality metric to a predetermined length of a transmission time interval for transmission of a data stream between the mobile station and the base station; and
selecting for use in data transmission between the mobile station and the base station the length of the transmission time interval associated with the determined data traffic volume and the calculated average value of the channel quality metric.

4. The method of claim 3, further comprising:
defining the maximum length of the transmission time interval by the determined data traffic volume.

5. The method of claim 1, wherein the calculating the average value of the channel quality metric comprises calculating the average value in the base station from a signal transmitted from the mobile station to the base station.

6. The method of claim 1, wherein the calculating the average value of the channel quality metric comprises calculating the average value in the mobile station from a signal transmitted from the base station to the mobile station, and
the method further comprising:
transmitting the channel quality metric from the mobile station to the base station.

7. The method of claim 1, further comprising:
transmitting, when a transmission time interval longer than a minimum transmission time interval is selected, the same payload data as would be sent with the minimum transmission time interval but with additional redundancy configured to facilitate detection of the payload data in a receiver.

8. The method of claim 1, wherein the calculating the average value of the channel quality metric comprises calculating an average signal-to-interference-plus-noise power ratio.

9. The method of claim 1, further comprising:
selecting the length of the transmission time interval individually for each mobile station communicating with the base station.

10. The method of claim 1, further comprising:
grouping a plurality of mobile stations communicating with the base station according to at least the calculated average values of the channel quality metrics associated with each of the plurality of mobile stations; and
selecting a given length of the transmission time interval for each group.

11. The method of claim 1, further comprising:
configuring the transmission time interval to be an integer number of minimum transmission time intervals.

12. The method of claim 11, further comprising:
configuring the minimum transmission time interval is one sub-frame of a frame used for transmitting data between the base station and the mobile station.

13. The method of claim 1, further comprising:
transmitting from the base station to the mobile station a control signal comprising information on the selected length of the transmission time interval; and
transmitting data between the base station and the mobile station in transmission time intervals of the selected length.

14. The method of claim 1, further comprising:
determining the length of the transmission time interval based on the average value of the channel quality metric for preselected channels used in the communication between the base station and the mobile station, and a fixed length of the transmission time interval is selected for the other channels.

15. An apparatus, comprising:
a processing unit configured to obtain an average value for a channel quality metric representing the quality of a radio channel between a mobile station and a base station communicating according to a frequency division multiplexing based high-speed packet radio service, associate the calculated average value of the channel quality metric to a predetermined length of a transmission time interval for transfer of data between the mobile station and the base station, and select for use in the data transfer between the mobile station and the base station, the length of the transmission time interval associated with the calculated average value of the channel quality metric.

16. The apparatus of claim 15, wherein the processing unit is further configured to associate a given range of the average value of the channel quality metric value to a given length of transmission time interval that provides the desired weighting for the amount of required control signaling and achievable system capacity for the given range of the channel quality metric value.

17. The apparatus of claim 15, wherein the processing unit is configured to determine a data traffic volume between the mobile station and the base station, associate the determined data traffic volume together with the calculated average value of the channel quality metric to a predetermined length of a transmission time interval for transmission of a data stream between the mobile station and the base station, and select for use in data transmission between the mobile station and the base station the length of the transmission time interval associated with the determined data traffic volume and the calculated average value of the channel quality metric.

18. The apparatus of claim 17, wherein the processing unit is configured to determine the maximum length of the transmission time interval from the determined data traffic volume.

19. The apparatus of to claim 15, further comprising:
an interface to transmit and receive signals related to communication between the base station and the mobile station.

20. The apparatus of claim 19, wherein the processing unit is configured to obtain the average value of the channel quality metric by calculating the average value of the channel quality metric from a signal received from the mobile station.

21. The apparatus of claim 19, wherein the processing unit is configured to obtain the average value of the channel quality metric by receiving the average channel quality metric from the mobile station.

22. The apparatus of claim 19, wherein the processing unit is further configured to control the interface to transmit, when the processing unit has selected a transmission time interval longer than a minimum transmission time interval, the same payload data as would be sent within the minimum transmission time interval but with additional redundancy to facilitate detection of the payload data in a receiver-side.

23. The apparatus of claim 19, wherein the processing unit is further configured to control the interface to transmit to the mobile station a control signal comprising information on the selected length of the transmission time interval and transfer data in transmission time intervals of the selected length.

24. The apparatus of claim 15, wherein the calculated average value of the channel quality metric is average signal-to-interference-plus-noise power ratio.

25. The apparatus of claim 15, wherein the processing unit is configured to select the length of the transmission time interval individually for each mobile station.

26. The apparatus of claim 15, wherein the processing unit is configured to group a plurality of mobile stations communicating with the base station according to at least the calculated average values of the channel quality metrics associated with each of the plurality of mobile stations and select a given length of the transmission time interval for each group.

27. The apparatus of claim 15, wherein the transmission time interval is an integer number of minimum transmission time intervals.

28. The apparatus of claim 27, wherein the minimum transmission time interval is one sub-frame of a frame used for transmitting data between the base station and the mobile station.

29. The apparatus of claim 15, wherein the processing unit is configured to determine the length of the transmission time interval based on the average value of the channel quality metric for preselected channels used in the communication between the base station and the mobile station, and select a fixed length of the transmission time interval for the other channels.

30. An apparatus, comprising:
an interface configured to transmit and receive signals transferred between a mobile station comprising the apparatus and a base station, the mobile station and the base station configured to communicate according to a frequency division multiplexing based high-speed packet radio service; and
a processing unit configured to calculate an average value for a channel quality metric representing the quality of a radio channel between the mobile station and the base station, transmit, through the interface, the average value of the channel quality metric to the base station for allocation of the length of a transmission time interval for data transfer between the mobile station and the base station, and receive, through the interface, a control signal comprising information on the length of the transmission time interval allocated to the mobile station for data transfer.

31. The apparatus of claim 30, wherein the processing unit is further configured to use the length of the transmission time interval allocated to the mobile station in data transfer between the mobile station and the base station.

32. A mobile telecommunication system, comprising:
a base station; and
at least one mobile station,
wherein the base station comprises a communication interface to provide radio communications with the mobile station and a processing unit configured to obtain an average value for a channel quality metric representing the quality of a radio channel between a mobile station and a base station communicating according to a frequency division multiplexing based high-speed packet radio service, associate the calculated-average value of the channel quality metric to a predetermined length of a transmission time interval for transfer of data between the mobile station and the base station, and select for use in the data transfer between the mobile station and the base station, the length of the transmission time interval associated with the calculated average value of the channel quality metric, and
wherein the mobile station comprises a communication interface to provide radio communications with the base station and a processing unit configured to receive, through the communication interface, a control signal comprising information on the length of the transmission time interval allocated to the mobile station for data transfer and transfer data with the base station in transmission time intervals of the allocated length.

33. A mobile telecommunication system, comprising:
a base station; and
at least one mobile station,
wherein the base station comprises a communication interface to provide radio communications with the mobile station and a processing unit configured to receive an average value for a channel quality metric representing the quality of a radio channel between the mobile station and the base station communicating according to a frequency division multiplexing based high-speed packet radio service, associate the calculated average value of the channel quality metric to a predetermined length of a transmission time interval for transfer of data between the mobile station and the base station, select for use in the data transfer between the mobile station and the base station, the length of the transmission time interval associated with the calculated average value of the channel quality metric, and transmit to the mobile station a control signal comprising information on the length of the transmission time interval selected for the mobile station for data transfer, and
wherein the mobile station comprises a communication interface to provide radio communications with the base station and a processing unit configured to calculate an average value for a channel quality metric representing the quality of a radio channel between the mobile station and the base station, transmit, through the communication interface, the average value of the channel quality metric to the base station, and receive, through the interface, a control signal comprising information on the length of the transmission time interval selected for the mobile station for data transfer.

34. An apparatus, comprising:
means for obtaining an average value for a channel quality metric representing the quality of a radio channel between a mobile station and a base station communicating according to a frequency division multiplexing based high-speed packet radio service;
means for associating the calculated average value of the channel quality metric to a predetermined length of a transmission time interval for transfer of data between the mobile station and the base station; and
means for selecting for use in the data transfer between the mobile station and the base station, the length of the transmission time interval associated with the calculated average value of the channel quality metric.

35. An apparatus, comprising:
means for calculating an average value for a channel quality metric representing the quality of a radio channel between a mobile station and a base station communicating according to a frequency division multiplexing based high-speed packet radio service;
means for transmitting the calculated average value of the channel quality metric to the base station for selection of the length of a transmission time interval for the mobile station; and
means for receiving a control signal comprising information on the length of the transmission time interval allocated to the mobile station for data transfer.

36. A computer program distribution medium readable by a computer and encoding a computer program of instructions for executing a computer process comprising:
obtaining an average value for a channel quality metric representing the quality of a radio channel between a mobile station and a base station communicating according to a frequency division multiplexing based high-speed packet radio service;
associating the calculated average value of the channel quality metric with a predetermined length of a transmission time interval for transfer of data between the mobile station and the base station; and
selecting for use in the data transfer between the mobile station and the base station, the length of the transmission time interval associated with the calculated average value of the channel quality metric.

37. The computer program distribution medium of claim 36, the distribution medium including at least one of the following media: a computer readable medium, a program storage medium, a record medium, a computer readable memory, a computer readable software distribution package, a computer readable signal, a computer readable telecommunications signal, or a computer readable compressed software package.

38. A computer program distribution medium readable by a computer and encoding a computer program of instructions for executing a computer process comprising:
calculating an average value for a channel quality metric representing the quality of a radio channel between a mobile station and a base station communicating according to a frequency division multiplexing based high-speed packet radio service;
transmitting the calculated average value of the channel quality metric to the base station for selection of the length of a transmission time interval for the mobile station; and
receiving a control signal comprising information on the length of the transmission time interval allocated to the mobile station for data transfer.

39. The computer program distribution medium of claim 38, the distribution medium including at least one of the following media: a computer readable medium, a program storage medium, a record medium, a computer readable memory, a computer readable software distribution package, a computer readable signal, a computer readable telecommunications signal, or a computer readable compressed software package.
